(19) United States
(12) Patent Application Publication
(10) Pub. No.: US 2023/0390923 A1
(43) Pub. Date: Dec. 7, 2023

(54) SYSTEM AND METHOD FOR PICKING AND PLACING ITEMS AND CONTACT PRESSURE SENSING ASSEMBLY FOR ITEM PICKING SYSTEMS

(71) Applicant: WOOTZANO LIMITED, Edinburgh (GB)

(72) Inventors: Thierry GARCIA, Edinburgh (GB); François MORINI, Edinburgh (GB); Atif SYED, Edinburgh (GB); Mark BECKWITH, Edinburgh (GB); Jesse OPOKU, Edinburgh (GB)

(21) Appl. No.: 18/034,023

(22) PCT Filed: Oct. 26, 2021
(86) PCT No.: PCT/GB2021/052778

§ 371 Date: Apr. 26, 2023

(30) Foreign Application Priority Data
Oct. 27, 2020 (GB) 2017045.2

(51) Int. Cl. B25J 9/16; B25J 19/02; B25J 13/08

(52) U.S. Cl. CPC B25J 9/1612; B25J 19/028; B25J 13/083

(57) ABSTRACT

An item picking system configured to pick items from a collection region for placing said items into an item container, the system comprising a robotic arm. One or more end effectors coupled to the robotic arm for holding and manipulating an item, wherein at least one of the end effectors comprises a contact pressure sensing assembly including a piezoresistive sensor configured to obtain piezoresistive signals indicative of contact pressure between said sensor and an item held by said end effector. Signal processing circuitry configured to process the piezoresistive signals, the signal processing circuitry comprising a differential amplifier having a first input terminal coupled to the sensor to receive the piezoresistive signals therefrom. A second input terminal arranged to receive a calibration signal and an output terminal for providing a difference signal based on the two input signals, wherein, for each piezoresistive signal provided to the differential amplifier, the system is configured to control the calibration signal provided to the second input terminal of the differential amplifier to be within a selected range from said piezoresistive signal. A control unit coupled to the output terminal of the differential amplifier, wherein the control unit is configured to control operation of the robotic arm based on the difference signals from the differential amplifier.

### TECHNICAL FIELD

The present disclosure relates to the field of sorting and/or packing items, such as items of fruit and/or vegetables.

### BACKGROUND

Once fruit and/or vegetables have been grown and harvested, they are sorted and packed into containers for transport to vendors (such as supermarkets) where they are sold. Typically, this process involves a plurality of human operators who select which fruit/vegetables to select for packing, as well as sorting where these are to be packed. This sorting and packing may have to be performed in accordance with rules specific to the relevant fruit and/or vegetables. For example, tomatoes may have to be grouped based on their size and colour. This can involve a large number of human operators to perform this sorting and packing (e.g. there may be three human operators involved for packing six tomatoes into a punnet). This may bring about inefficiencies in the supply chain such as limiting the throughput of fruit and/or vegetables to be sorted, as well as introducing a number of subjective judgements which the human operators will have to make to determine how to sort and/or pack the fruit and/or vegetables.

### SUMMARY

Aspects of the disclosure are set out in the independent claims and optional features are set out in the dependent claims. Aspects of the disclosure may be provided in conjunction with each other, and features of one aspect may be applied to other aspects.

In an aspect, there is provided an item picking system configured to pick items from a collection region for placing said items into an item container. The system comprises: a robotic arm; one or more end effectors coupled to the robotic arm for holding and manipulating an item. At least one of the end effectors comprises a contact pressure sensing assembly including a piezoresistive sensor configured to obtain piezoresistive signals indicative of contact pressure between said sensor and an item held by said end effector. The system further comprises signal processing circuitry configured to process the piezoresistive signals, the signal processing circuitry comprising a differential amplifier having: (i) a first input terminal coupled to the sensor to receive the piezoresistive signals therefrom; (ii) a second input terminal arranged to receive a calibration signal; and (iii) an output terminal for providing a difference signal based on the two input signals. For each piezoresistive signal provided to the differential amplifier, the system is configured to control the calibration signal provided to the second input terminal of the differential amplifier to be within a selected range from said piezoresistive signal. The system further comprises a control unit coupled to the output terminal of the differential amplifier, wherein the control unit is configured to control operation of the robotic arm based on the difference signals from the differential amplifier.

Embodiments may enable precise piezoresistive sensor measurements to be obtained for a wide variety of signal voltages. For example, the system may be configured to control a voltage of the calibration signal to be within a range where it can be measured to a high degree of precision and/or where it is within an operational range of a component for measuring that voltage. For example, the system may comprise a microcontroller comprising an analogue to digital converter (ADC′) configured to measure an indication of the voltage, e.g. the difference signal may be provided to an ADC input to the microcontroller. The microcontroller may only be operable to determine voltage in a selected voltage range (e.g. 0 to 5 V, or 0 to 3.3 V). The system may be configured to control the calibration signal applied to the differential amplifier so that the resulting difference signal falls within the operational range of the microcontroller ADC. This may enable more precision for the measured voltage value, and/or may inhibit damage from occurring to the microcontroller by providing too high voltages to its ADC input.

The control unit may be configured to control at least one of the end effectors to change its grip on the item in the event that the difference signal indicates at least one of: (i) the contact pressure between the sensor and the item held by said end effector is outside a selected pressure range, (ii) the contact pressure between the sensor and the item held by said end effector has changed by more than a threshold amount while the item has been grasped by said end effector, (iii) the contact pressure between the sensor and the item held by said end effector is changing at above a threshold rate of pressure change. The control unit may be configured to control at least one of the end effectors to change its grip on the item to increase the contact pressure in the event that the contact pressure: is below a threshold value, has decreased by more than the threshold amount, and/or is decreasing above the threshold rate.

The pressure sensing assembly of the end effector may comprise a plurality of piezoresistive sensors configured to obtain piezoresistive signals indicative of contact pressure between each said sensor and the item held by the one or more end effectors. The at least one end effector may comprise a plurality of end effectors, for example wherein each end effector comprises a digit. The control unit may be configured to: (i) obtain an indication of a value for the piezoresistive signal, and (ii) generate a calibration signal to be provided to the second input terminal based on the indication of the value for the piezoresistive signal. The control unit may be configured to generate the calibration signal to be within a selected voltage range of a voltage of the piezoresistive signal. The selected voltage may be within volts of the voltage of the piezoresistive signal, e.g. within 10 volts of the voltage of piezoresistive signal, e.g. within 7 volts, e.g. within 5 volts.

The end effector may comprise one or more lights configured to indicate a value for a contact pressure between the one or more end effectors and the item held by the end effectors. The signal processing circuitry may comprise a splitter configured to direction a portion of the piezoresistive signal to the one or more lights. The signal processing circuitry may comprise a diode configured to power the display based on the piezoresistive signal. The pressure sensing assembly may further comprise a piezoelectric sensor configured to obtain piezoelectric signals indicative of contact pressure between said piezoelectric sensor and an item held by the digits. The control unit may be configured to control operation of the robotic arm based on a comparison between the piezoelectric signals and the piezoresistive signals.

The signal processing circuitry may comprise a multiplexer operable to selectively provide piezoresistive signals from the plurality of sensors to the first input terminal of the differential amplifier. The control unit may be configured to process difference signals to determine an indication of a voltage drop associated with the corresponding piezoresistive sensor. The control unit may be configured to determine an indication of pressure between a piezoresistive sensor and an item held by the end effectors based on a voltage drop associated with said piezoresistive sensor. The control unit may comprise an analogue to digital converter, ADC, configured to obtain a digital difference signal based on the difference signal provided by the differential amplifier. The control unit may further comprises a digital to analogue converter, DAC, configured to generate an analogue signal based on the digital difference signal. The calibration signal provided to the second input terminal of the differential amplifier may comprise the analogue signal generated by the DAC. The control unit may be configured to iteratively change the analogue signal generated by the DAC until the calibration signal provided to the second input terminal of the differential amplifier is within the selected range from the piezoresistive provided to the first input terminal of the differential amplifier. The control unit may be configured to control operation of the robotic arm based on the difference signal from the differential amplifier when the calibration signal provided to the second input terminal of the different amplifier is within the selected range from the piezoresistive signal provided to the first input terminal of the differential amplifier. The DAC may comprise a pulse width modulator, one or more filters, and an amplifier.

The item picking system may be configured to pick items of fruit or vegetables. For example, it may be configured to handle softer or more delicate items than e.g. boxes. For example, this may comprise use of higher sensitivity pressure sensors, e.g. which are operable to obtain an indication of pressure sufficiently precisely between a pressure value which is too high and which may damage the fruit/vegetable, and pressure value at which the item cannot be held, to enable the items to be grasped and moved without being dropped or damaged by over-squeezing.

At least one of the end effectors may comprise a piezoelectric sensor. The control unit may be configured to control operation of the robotic arm based also on piezoelectric signals obtained by the piezoelectric sensor.

In an aspect, there is provided a contact pressure sensing assembly comprising: an electronic skin for digits of an end effector of a robotic arm, wherein the electronic skin comprises: (i) a plurality of piezoresistive sensors each configured to obtain piezoresistive signals; and (ii) a plurality of piezoelectric sensors each configured to obtain piezoelectric signals; a control unit coupled to the electronic skin to receive the piezoresistive and piezoelectric signals therefrom. The control unit is configured to process the piezoresistive signals to identify one or more piezoresistive parameters associated therewith, and to process the piezoelectric signals to identify one or more piezoelectric parameters associated therewith. The control unit is operable to identify that an item held by the digits of the end effector is moving relative to the electronic skin based on a difference in magnitude and/or phase between: (i) one or more of the piezoelectric parameters in piezoelectric signals from one piezoelectric sensor, and (ii) one or more of the piezoelectric parameters in piezoelectric signals from another piezoelectric sensor. The control unit is configured to determine a contact pressure between the item and a first digit associated with said one piezoelectric sensor based on one or more of the piezoresistive parameters from piezoresistive signals associated with the first digit.

Embodiments may enable more responsive and/or pressure sensing, as well as to enable more reliability in pressure sensing, as results from piezoelectric sensors may provide complementary information to that obtained using piezoresistive sensors (and vice versa). For example, the combination of sensor data may enable the assembly to perform a cross-checking or comparison between sensor data (e.g. to increase reliability that a measurement from one type of sensor is correct). The assembly may be able to detect an indication of a change in pressure (e.g. due to some movement of the item relative to the digit) using the piezoelectric sensors, and to monitor an indication of the contact pressure (e.g. its magnitude/direction etc.) using the piezoresistive sensors. This may enable quicker detection of movement in combination with real-time monitoring of contact pressure.

In response to identifying that an item held by the digits of the end effector is moving relative to the electronic skin for the first digit based on the piezoelectric signals, the control unit may be configured to monitor piezoresistive signals associated with the first digit to confirm that the item is moving relative to the electronic skin for the first digit. The control unit may be configured to determine a direction of movement of the item based on a phase difference between different piezoelectric signals. For at least one of the digits of the end effector, the electronic skin may comprise a first piezoelectric sensor and a second piezoelectric sensor located away from the first piezoelectric sensor. The control unit may be configured to determine whether the item is moving in the direction of the first piezoelectric sensor or the second piezoelectric sensor based on piezoelectric signals from the first and second piezoelectric sensors. The one or more piezoresistive parameters may comprise a change in voltage associated with the sensor, and/or wherein the one or more piezoelectric parameters comprise any of: a maximum voltage, a minimum voltage, a change in voltage and/or a rate of change of voltage.

In an aspect, there is provided an item picking system configured to pick items from a collection region for placing said items into an item container. The system comprising: a robotic arm; and an end effector coupled to the robotic arm comprising at least two digits for holding and manipulating an item therebetween, wherein the end effector comprises a contact pressure sensing assembly. The contact pressure sensing assembly comprises an electronic skin arranged to at least partially cover the digits of the end effector, the electronic skin comprising: (i) a plurality of piezoresistive sensors each configured to obtain piezoresistive signals; and (ii) a plurality of piezoelectric sensors each configured to obtain piezoelectric signals. The system comprises a control unit configured to control operation of the digits based on piezoelectric signals and piezoresistive signals received from the electronic skin.

The control unit may be operable to identify that an item held by the digits of the end effector is moving relative to the electronic skin based on a difference in magnitude and/or phase between: (i) one or more voltage parameters for piezoelectric signals from one piezoelectric sensor, and (ii) one or more voltage parameters for piezoelectric signals from another piezoelectric sensor. The control unit may be configured to control at least one of the digits to move in the event that it is determined that an item held by the digits of the end effector is moving relative to the electronic skin. The control unit may be configured to determine a direction of movement of the item based on a phase difference between different piezoelectric signals. The control unit may be configured to control at least one of the digits to move relative to the item, wherein the control unit is configured to determine a direction in which the digit is to move based on the determined direction of movement of the item. In the event that the control unit determines that the item is moving relative to a first digit, the control unit may be configured to determine a contact pressure between the item and the first digit based a change in voltage from piezoresistive signals on the first digit.

In an aspect, there is provided an ohmmeter configured to measure a voltage drop across a piezoresistive sensor to determine a resistance of the piezoresistive sensor in each of a plurality of different, separate, resistance ranges. The ohmmeter comprises: a coupling port for coupling the ohmmeter to an output conductor of the piezoresistive sensor to receive piezoresistive signals therefrom; a plurality of resistors at different resistance values, wherein each of the resistors is connected to the coupling port; a differential amplifier having: (i) a first input terminal connected to the connection between each of the resistors and the coupling port, (ii) a second input terminal arranged to receive a reference voltage, and (iii) an output terminal for providing a difference signal; and a control unit coupled to the output terminal of the differential amplifier for receiving difference signals therefrom, wherein the control unit comprises a microcontroller having a plurality of pins, wherein each of the plurality of resistors is connected between a respective pin of the microcontroller and the connection between the resistors and the coupling port. The control unit is configured to selectively control the pin status of each of the pins of the microcontroller to be in either: (i) a first state in which the resistor corresponding to that pin forms a potential divider with the first input terminal of the differential amplifier and any other resistors in their first state for a piezoresistive signal provided to the coupling port, and (ii) a second state in which the resistor does not form a said potential divider. The control unit is configured to select the state of each of the microcontroller pins so that a voltage provided to the first input terminal of the differential amplifier is within a selected range from the reference voltage.

Embodiments may enable resistances to be measured in each of a plurality of different resistance ranges. For example, the control unit and the microcontroller may be part of the same component. For example, the microcontroller may comprise the control unit. An ADC input for the microcontroller may be used to determine a voltage associated with the difference signal from the differential amplifier. The microcontroller may only be operable to determine voltage in a selected voltage range (e.g. 0 to 5 V, or 0 to 3.3 V). The system may be configured to control the state of the microcontroller pins so that the resistance of the resulting potential divider is such that a voltage the signal applied to the first terminal of the differential amplifier is sufficiently close to a voltage of the reference signal provided to the second input terminal of the differential amplifier that the resulting difference signal falls within the operational range of the microcontroller ADC. This may enable more precision for the measured voltage value, and/or may inhibit damage from occurring to the microcontroller by providing too high voltages to its ADC input.

For each piezoresistive signal provided to the coupling port, the control unit may be configured to monitor the difference signal from the differential amplifier and to control the state of each microcontroller pin based on said difference signal until the voltage provided to the first input terminal of the differential amplifier is within the selected range from the reference voltage. For each piezoresistive signal provided to the coupling port, the control unit may be configured to iteratively decrease the effective resistance applied to said piezoresistive signal until the voltage provided to the first input terminal of the differential amplifier is within the selected range from the reference voltage.

In an aspect, there is provided a method of controlling a robotic arm for picking items from a collection region for placing said items into an item container. The method comprises: operating a robotic arm having a plurality of end effectors to grasp an item between the end effectors; using a piezoresistive sensor of one of the end effectors to obtain one or more piezoresistive signals indicative of pressure between said end effector and the item; providing the piezoresistive signal to a first input terminal of a differential amplifier and providing a calibration signal to a second input terminal of the differential amplifier, wherein the method comprises controlling the calibration signal to be within a selected range from the piezoresistive signal; and controlling operation of the robotic arm based on a difference signal obtained from an output terminal of the differential amplifier.

In an aspect, there is provided a method of measuring a voltage drop across a piezoresistive sensor to determine a resistance of the piezoresistive sensor in each of a plurality of different, separate, resistance ranges. The method comprises: receiving a piezoresistive signal from the piezoresistive sensor; controlling a plurality of pins of a microcontroller to selectively form a potential divider for the piezoresistive signal between a first input terminal of a differential amplifier and one or more resistors each connected to a respective pin of the microcontroller; providing a reference voltage to a second input terminal of the differential amplifier. The method comprises controlling the pins of the microcontroller to form such a potential divider so that the voltage provided to the first input terminal of the differential amplifier is within a selected range from the reference voltage.

Aspects of the present disclosure provide computer program products comprising computer program instructions configured to program a control unit to perform any of the methods disclosed herein.

### FIGURES

Some examples of the present disclosure will now be described, by way of example only, with reference to the figures, in which:

FIG. 1 shows a schematic diagram of an exemplary system for sorting and/or packing items of fruit and/or vegetables.

FIG. 2 shows a schematic diagram of a contact pressure sensing assembly and signal processing circuitry for processing contact pressure signals from the assembly.

FIG. 3 shows an ohmmeter for measuring resistance associated with piezoresistive signals. In the drawings like reference numerals are used to indicate like elements.

### SPECIFIC DESCRIPTION

Embodiments of the present disclosure are directed to systems and methods for sorting and/or packing items, such as items of fruit and/or vegetables. A robotic arm is used in combination with an end effector coupled to the end of the robotic arm. The end effector is operable to grasp an item of fruit or vegetable (e.g. the end effector may comprise one or more digits). Embodiments are directed to systems for sensing and processing a contact pressure for contact between the end effector and the item. Embodiments are directed to systems for processing piezoresistive and/or piezoelectric signals to identify one or more parameters of those signals based on which an indication of one or more properties of contact pressure may be determined.

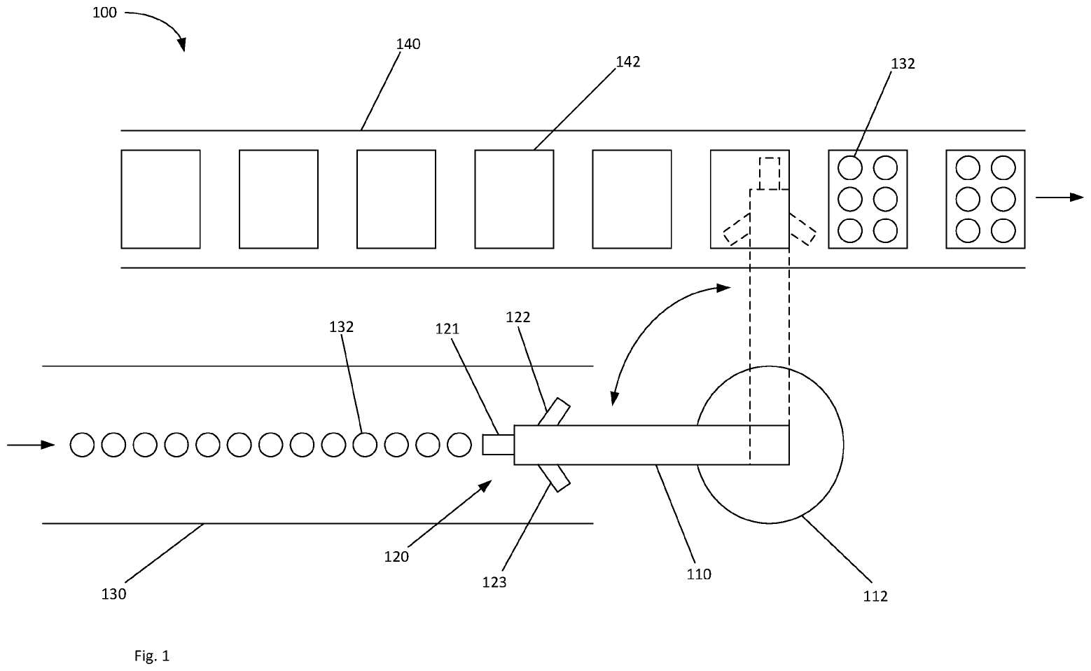

An exemplary fruit and/or vegetable packing system will now be described with reference to FIG. 1.

FIG. 1 shows a fruit and vegetable packing system 100. The system 100 includes a first robotic arm 110 which has a first end effector 120 coupled thereto. In the example of FIG. 1, the first end effector 120 comprises three end effectors in the form of digits. As such, the first end effector 120 includes a first digit 121, a second digit 122 and a third digit 123. The first robotic arm 110 is provided on a movable platform 112. The system 100 also includes a first moving surface 130 and a second moving surface 140. A plurality of items or fruit or vegetables 132 are provided on the first moving surface 130, and a plurality of punnets 142 are provided on the second moving surface 140 into which the items of fruit or vegetables are placed.

The first robotic arm 110 extends radially outward from a central region. The arm has a proximal end located proximal to the central region and a distal end located away from the central region. The first end effector 120 is coupled to the robotic at or proximal to its distal end. The digits of the first end effector 120 are arranged about the distal end of the arm. In the example shown, there are three digits (although it is to be appreciated that this is merely an example, other numbers may be provided), and these are distributed about the distal end of the arm. As shown, they are distributed evenly about a coupling point between the first end effector 120 and the first robotic arm 110 (e.g. they each extend radially outwardly from this coupling point, and are separated by 120°). Each digit is coupled to a body of the first end effector 120 or the first robotic arm 110 at a coupling end of the digit, and each digit extends from its coupling end to its grasping end, which is distal to the first end effector 120 body/first robotic arm 110. The first robotic arm 110 includes one or more (e.g. two) rotation points, such as hinges, along its length from its proximal end to its distal end. The first robotic arm 110 is provided on top of the movable platform 112.

The first moving surface 130 is located close enough to the second moving surface 140 for the first robotic arm 110 to move fruit or vegetables from the first moving surface 130 to the second moving surface 140. This movement may comprise a rotation of the arm (although additionally or alternatively, the radius of the arm may be shortened or lengthened for this process). In the example shown, the first moving surface 130 runs parallel to the second moving surface 140. The first robotic arm 110 may rotate approximately 90° when moving between the moving surfaces.

The first robotic arm 110 is configured to rotate about its central axis (e.g. a vertical axis at the proximal end of the first robotic arm 110). The first robotic arm 110 is operable to shorten or lengthen its radius. This shortening/lengthening may be provided by raising or lowering a rotation point of the first robotic arm 110. The first robotic arm 110 is operable to vary the height of the distal end of the first robotic arm 110. For example, the first robotic arm 110 is configured to pivot about its proximal end (e.g. about a point on the vertical axis at the proximal end). This may increase or decrease the height of the distal end of the first robotic arm 110 depending on the pivoting direction. The first robotic arm 110 is coupled to one or more driving means, such as a motor, which are configured to control any of the rotating/pivoting/lengthening/shortening movement of the arm. The arm is configured to enable fruit or vegetables to be grasped and lifted from the first surface 130, then moved so that they may be placed into punnets 142 on the second surface 140.

The movable platform 112 is configured to provide a secure base from which the robotic may operate. The movable platform 112 is configured for movement of the first robotic arm 110, e.g. between different locations in a warehouse. The movable platform 112 may comprise a trolley. The height of the first robotic arm 110 above ground may be varied by the movable platform 112 (e.g. the height of the movable platform 112 may be adjustable, or different height movable platforms may be used). For example, the movable platform 112 may enable the robotic arm 110 to be transported to different packing stations, e.g. where it may subsequently be used to pack a different item of fruit or vegetable.

The first end effector 120 and its digits are configured for grasping items of fruit and/or vegetables. The first end effector 120 is configured so that the fruit or vegetables can be held tightly enough that they do not fall from the first end effector 120. The system may control operation of the first end effector 120 so that items are not held so tightly that they are damaged in the process. Each of the digits may be independently movable. This may comprise translational movement (e.g. in a horizontal plane), as well as rotational movement (e.g. about their connection point to the body of the first end effector 120 and/or the first robotic arm 110). Each digit may be configured to increase or decrease its length from the first robotic arm 110, such as to vary its height. This may bring the grasping end closer to, or further away from, the first robotic arm 110. For example, each digit may include one or more rotation points along its length about which rotation may provide lengthening or shortening of the digit. For example, the digits may comprise one or more pivot points to enable rotation along their length, e.g. they may be operable to operate in a manner analogous to human fingers. Movement of the digits is controlled by a driving means, such as a motor.

At least one of the digits comprises a pressure sensing assembly. The pressure sensing assembly may comprise a plurality of different contact points on the digits which are each arranged to enable an indication of the pressure being applied to the fruit or vegetable by that region of the digit to be obtained. The pressure sensing assembly is configured to give a plurality of sensor readings in the time period for grasping an item of fruit or vegetable (e.g. from a plurality of different contact locations on the digit). The system 100 is configured to monitor the pressure on the fruit or vegetable during the process of picking and placing into a punnet 142. The pressure may be used to determine when it is safe to lift an item of fruit or vegetable (e.g. once the pressure is above a threshold level), and/or whether the item is being held correctly (e.g. if it is moving relative to one or more of the digits). The system 100 is configured to control movement of the digits based on the pressure reading. For example, in the event that the pressure is too low in one or more regions (e.g. it is below a threshold value), or is decreasing, the digits may be moved to increase this pressure (moved towards each other, and/or in a direction based on a determined direction of movement for the item). Likewise, digits may be moved apart if the pressure is too high. The system 100 is configured to use pressure readings to determine that the fruit or vegetable is held securely enough to be moved, but not too tightly that it will be damaged during movement.

The first surface 130 is arranged to move items of fruit and/or vegetables towards the first robotic arm 110 and first end effector 120. The first surface 130 is configured to provide items to the first robotic arm 110 at a speed and frequency to enable the arm and first end effector 120 to grasp each item and place it accordingly. The first surface 130 may be switchable between moving and being stationary. Each item may be moved into a collection region, where that item is within reach of the first robotic arm 110. Once an item is in the collection region, the first surface 130 may be stopped to enable that item to be collected by the arm. However, it is to be appreciated that the first surface 130 may run continuously at a speed selected so that each item is in the collection region at the correct time. Items are placed on the first surface 130 at a proximal end of the first surface 130, and moved towards the first robotic arm 110 at a distal end of the first surface 130. The items may be arranged on the first surface 130 so that one item is collected at a time. The first surface 130 may be a conveyor belt.

The second surface 140 is arranged to move open punnets (e.g. punnets with room for more fruit and/or vegetables) towards the first robotic arm 110 so that the robotic arm 110 may place items from the first surface 130 into open punnets on the second surface 140. The second surface 140 is arranged to move full punnets onwards away from the first robotic arm 110. The second surface 140 is arranged so that open punnets are loaded onto a proximal end of the second surface 140. The second surface 140 is configured to move these open punnets in a distal direction so that they pass within reach of the first robotic arm 110, and then onwards to a distal end of the second surface 140. As with the first surface 130, the second surface 140 may either stop and start to facilitate placement of items in punnets, or it may run continuously at a speed to enable each punnet to be filled while within a filling region of the second surface 140 in which it is within reach of the first robotic arm 110. The second surface 140 may be a conveyor belt.

Items of fruit or vegetable may comprise any suitable fruit or vegetable which are to be packed into punnets. For example, tomatoes, grapes, strawberries etc. may all be used. Punnets may comprise any suitable container for storing the relevant items of fruit or vegetable. The second surface 140 will receive punnets in an open state so that they may be packed. Once packed, punnets may be sealed. However, it is to be appreciated in the context of the present disclosure that the system may find utility for other items (e.g. which are not items of fruit or vegetable, such as other foodstuffs to be packaged into item containers).

The pressure sensing assembly may comprise a plurality of different contact sensing locations on one or more of the digits. In other words, the pressure sensing assembly may comprise a plurality of spatially distributed pressure sensors. This distribution of pressure sensors may be configured to obtain a spatial distribution of contact pressure for contact between the digits of the end effector and an item held by the digits. This spatial distribution of contact pressure may comprise an indication of a magnitude of contact pressure for contact between at least one of the digits and the item held by the digits. The spatial distribution of contact may comprise a plurality of such magnitudes of contact pressure for contact at each of a plurality of different locations. Based on the plurality of different contact pressure sensing measurements, an indication of a direction of contact pressure for contact between the at least one item and the digits may be obtained. This indication of a direction of contact pressure may comprise an indication of how contact pressure varies across different regions of the surface of the item. This may also provide an indication of higher and lower pressure regions, and this may provide an indication of directionality for pressure between the digits and the item. For example, if two adjacent sensors have different contact pressures, this may indicate that one is gripping tighter than the other, e.g. because one of the sensors is on a digit which is in the wrong place, and/or the shape of the item may be such that the pressure distribution is not even for contact with said item. The spatial distribution of contact pressure may provide an indication of a direction in which one or more of the digits could move relative to the item to get a better grip on the item (e.g. so that the item is no longer moving, or contact pressure between the digits and the item is more evenly distributed about the items surface).

The plurality of contact pressure sensing locations are configured to repeatedly (e.g. continuously) provide contact pressure sensing data. For example, each contact pressure sensing location may comprise a piezoresistive sensor configured to monitor a voltage drop associated with contact in that contact sensing region. The plurality of contact sensors are arranged to enable detection of movement of the item relative to the digits. For example, the contact sensing regions may be distributed about the one or more digits to provide an indication of pressure for the majority or all of the contact area of the digit. The system may be configured to monitor the spatial distribution of pressure, and how this changes over time, to determine if an item is moving. For example, if pressure in one region is decreasing (e.g. consistently decreasing, or has moved to a low value), it may be inferred that the item is moving away from that region (and thus there is no contact, i.e. contact pressure, between the digit and the item in that region).

The system 100 is configured to control operation of the first robotic arm 110 and first end effector 120 based on sensor signals from the pressure sensing assembly. For example, the system 100 may be configured to control operation of the first robotic arm 110 and the first end effector 120 based on an indication of both: (i) a magnitude of one or more contact pressures, and (ii) a direction of contact pressure.

Not all items may be placed in punnets. For example, the system 100 may determine that an item is too big or too small for an open punnet, and this item may be placed in a different region where it may be e.g. discarded or transported elsewhere for packing. Open punnets closer to the distal end of the second surface 140 may be prioritised over those nearer the proximal end of the second surface 140, or open punnets may be filled one at a time (e.g. a first open punnet will be filled with items before then filling a subsequent open punnet). The system 100 may be configured to place an item into the distalmost open punnet intended to receive an item of that size. Once a selected number of items are placed into a punnet, that punnet will be full (e.g. one punnet may hold six items, such as tomatoes). The system 100 may be configured to avoid placing items in full punnets.

The system 100 may be configured to determine the size of an item using pressure measurements. The system 100 is configured to determine whether the first end effector 120 is correctly holding the item. Determining whether the first end effector 120 is correctly holding the item may comprise using the pressure sensor to determine how tightly gripped the item is. For example, at a pressure below a selected threshold, it may be determined that the digits are not adequately gripping the item (e.g. they may need to move closer to one another/towards the item and so the size of the item is smaller than the displacement between digits would suggest). As another example, at a pressure above a selected threshold, it may be determined that the digits are gripping the item too tightly (e.g. they may need to be separated further and so the size of the item is greater than the displacement between the digits would suggest).

The system 100 may be configured to determine that the first end effector 120 is correctly holding the item based on a direction of contact pressure. For example, if the spatial distribution of contact pressures indicates that the item has an even distribution of contact pressure with the digits, e.g. if all, or a majority, of the contact pressure measurements are within a selected range from one another, it may be determined that the item is held correctly. The system 100 may be configured to determine that the first end effector 120 is correctly holding the item based on an indication of whether the item is moving relative to the digits. For example, if it is determined that the item is stationary, e.g. moving below a threshold speed, relative to the digits, then it may be determined that the item is held correctly.

The system 100 may be configured to determine that an item is not held correctly if, based on sensor signals from the pressure sensing assembly, it is determined that at least one of: (i) a magnitude of contact pressure (e.g. from one or more of the contact pressure sensing regions) has changed by more than a first amount; (ii) a magnitude of contact pressure (e.g. from one or more of the contact pressure sensing regions) is changing by more than a first rate of change; (iii) a direction of contact pressure has changed by more than a second amount; (iv) a direction of contact pressure is changing by more than a second rate of change; (v) a magnitude of contact pressure is changing while the indication of the direction of contact pressure remains constant; (vi) a direction of contact pressure is changing while the indication of the magnitude of contact pressure remains constant; (vii) the item is moving at more than a threshold speed relative to the digits of the end effector; and (viii) the item has moved more than a threshold distance relative to the digits of the end effector.

In the event that it is determined that the item is not being held correctly, the system 100 may be configured to move one or more of the digits relative to the item. Where the magnitude of contact pressure in a contact region is outside a selected range, the corresponding digit may be moved relative to the item so that the contact pressure is in the selected range. If the contact pressure between a digit and the item is too high, that digit may be moved away from the digit until the contact pressure is within the selected ranged, and vice versa.

Where the direction of contact pressure indicates a non-uniform distribution of pressure on the item, one or more of the digits may be moved to balance the distribution of pressure to the item. If one or more of the contact pressure sensing regions indicate a contact pressure which is outside a selected range from contact pressures from other contact pressure sensing regions (e.g. too high or too low), the digit may move relative to the item to provide a more balanced spatial distribution of contact pressure. This may comprise moving the digit towards or away from the centre of the item, and/or moving the digit to a different location on the surface of the item. For example, the direction of contact pressure may suggest a higher contact pressure between one part of a digit than another part of that same digit. From this it may be inferred that the shape of the item is such that the digit is in the wrong place, e.g. the shape may be non-uniform. The digit may be controlled to move around the surface of the item to a location where the contact pressure distribution between that digit and the item becomes more uniform, e.g. so that any irregularities in shape are not impeding there being a consistent grip on the item (for example so that the item is being gripped in regions where its shape conforms more closely to the surface of the digits).

Where the sensor signals from the pressure sensing assembly indicates that the item is moving relative to the digits, the digits may be controlled to stop this movement. For example, the digits may be controlled to grip the item more tightly to prevent movement. For example, the digits may be moved in a direction based on the direction of movement of the item, e.g. so that the digits are in a position to oppose this movement of the item. Detection of movement may be based on the magnitude of contact pressure in different regions and/or an indication of direction for the contact pressure.

One example of operation of the system 100 of FIG. 1 will now be described. In this example, the items to be packed are tomatoes. The tomatoes are to be sorted based on size. In particular, two size ranges are defined: the first range is for tomatoes having a diameter between 67 mm and 81 mm, and the second range is for tomatoes having a diameter between 82 mm and 101 mm.

A plurality of tomatoes are placed on the first surface 130 and a plurality of punnets are placed on the second surface 140. Two open punnets are identified: a first open punnet is for tomatoes in the first range, and a second open punnet is for tomatoes in the second range.

The first surface 130 moves the tomatoes towards the first robotic arm 110. The first robotic arm 110 then moves towards a first tomato on the first surface 130, and the digits of the first end effector 120 are controlled so that they move towards grasping the first tomato. The digits are moved towards the first tomato until the pressure sensor indicates that the pressure of the digits grasping the tomato is above a threshold value (e.g. is within a selected threshold range). In the event that it is determined that the pressure is above the threshold value (or within the selected range), it may be determined that the tomato is held properly. The robotic arm 110 is then controlled to lift the tomato. During this movement of the tomato, sensor signals from the pressure sensing assembly are monitored to ensure the item is held correctly. In the event that the tomato is determined not to be held correctly, then the digits will be controlled to change their grip on the tomato so that the tomato is subsequently held correctly. Therefore, during operation the tomato will be held correctly by the end effector 120.

During operation, an indication of a diameter of the tomato is obtained. For example, this may comprise taking a displacement measurement for the digits grasping the first tomato (e.g. to obtain an indication of the relative displacement between different digits). Based on this displacement measurement, an indication for the diameter of the tomato is identified. Alternatively, or additionally, an indication of a diameter may be obtained using, e.g. a camera and image recognition and analysis to determine a diameter of the tomato. Where a displacement measurement is taken, a pressure measurement may also be taken (or the existing pressure measurement used) to check that the pressure is within a selected range. In the event that the pressure is in the selected range, it may be determined that the first tomato remains held properly, and so the diameter measurement is valid. The first robotic arm 110 then moves the first tomato and places it into one of the first or the second punnets depending on the determined diameter of the tomato. This process is repeated for subsequent tomatoes on the first surface 130.

In the event that a tomato is placed into a punnet, and that punnet is then deemed to be full (e.g. it has six tomatoes in it), that punnet is no longer identified as an open punnet. A new punnet will then be identified as an open punnet for tomatoes in the first or second range (depending on which punnet was filled). It may be that the tomatoes have predetermined punnets into which they are to be placed (e.g. punnets for the first range are different to punnets for the second range). In which case, the next suitable punnet is identified. It may be that the punnets for the first and second ranges are the same. In which case, the next empty punnet is identified as an open punnet for the relevant range. Either way, once a punnet is full, the next open punnet for that range is identified, and tomatoes having a diameter corresponding to that range are then placed into that open punnet.

In the event that a pressure value for a tomato varies while in contact with the digits of the first end effector 120 (e.g. while a diameter measurement is being taken, or while being moved into an open punnet), the digits may be controlled based on this change in pressure value. If the pressure is increasing above a threshold rate, or has increased above a threshold amount (or to above a threshold pressure limit), the digits are opened until the pressure returns to its selected range. At which point, an additional displacement measurement may be obtained to identify to which diameter range that tomato belongs. If the pressure is decreasing above a threshold rate, or has decreased by a threshold amount (or to below a threshold pressure limit), the digits are closed until the pressure returns to its selected range. At which point, an additional displacement measurement may be obtained to identify to which diameter range that tomato belongs.

Tomatoes may therefore be sorted depending on size, and packed accordingly while ensuring that the tomatoes are held securely, but not too tightly, during the process.

Contact pressure sensing assemblies of the present disclosure may comprise one or more piezoresistive sensors and/or one or more piezoelectric sensors. Embodiments of the present disclosure are configured to control operation of a robotic arm and one or more end effectors coupled thereto based on sensor measurements obtained from the contact pressure sensing assembly. Based on such sensor measurements, an indication of a magnitude of contact pressure between the digits and the item may be obtained, as may an indication of a direction of a contact pressure between the two. Based on such sensor measurements, the system may also be configured to determine that an item is moving relative to the digits, and also optionally an indication of the direction of such movement.

Embodiments of the present disclosure may utilise an electronic skin for the digits to provide pressure sensing. For example, each digit may have an electronic skin thereon. The electronic skin may cover the region of the digit which comes into contact with the item during use. The electronic skin may be made from a substrate comprising a base polymer layer, with a first intermediate polymer layer attached to the base polymer layer by a first adhesive layer. The first intermediate polymer layer may comprise a first intermediate polymer in which electron-rich groups are linked directly to one another (or e.g. these may optionally be substituted by C₁₋₄ alkanediyl groups). The skin may further include a first conductive layer attached to the first intermediate polymer layer by a second adhesive layer or by multiple second adhesive layers between which a second intermediate polymer layer or a second conductive layer is disposed. Nanowires may be present on the first conductive layer. The nanowires may comprise a piezoelectric material. Said nanowires may be provided to enable piezoelectric pressure sensing.

The nanowires may comprise a conductive material, and preferably a metallic conductive material, where the metal in the metallic conductive material is preferably selected from zinc and silver, and more preferably is zinc, e.g. in the form of zinc oxide. The metallic conductive material may be in a crystalline form. The nanowires may extend away from the surface of the first conductive layer. A first end of the nanowires may be tethered to the first conductive layer. The nanowires may have an aspect ratio of from 1.5 to 100, preferably from 4 to 50, and more preferably from 6 to 20. The nanowires may be substantially vertically aligned. The nanowires, e.g. the surface of the nanowires may be functionalised with a species which enhances the sensory, e.g. piezoresistive or piezoelectric, response of the electronic skin when it comes into contact with a target species, for instance the nanowires may be functionalised with a binder, a catalyst or a reagent. The nanowires may be functionalised with a functional group, preferably selected from amino (—NH₂), hydroxy (—OH), carboxy (—COOH), amido (—CONH₂) and sulfanyl (—SH) groups. The nanowire may be functionalised with a catalyst, the catalyst preferably cleaving a target species into sub-sections, with one of the sub-sections inducing a sensory response in the electronic skin.

The substrate may comprise a pair of electrical contacts through which a sensory response of the nanowires is transmitted. For example, said substrate may provide pressure sensing for the digits, e.g. the pressure sensor may comprise the electronic skin on the digits. The substrate may comprise a third conductive layer to which the second end of each nanowire is preferably tethered. A sensory, e.g. piezoelectric, response of the nanowires may be transmitted through a pair of electrical contacts, one of which is attached to the first conductive layer and the other of which is attached to the third conductive layer. The first and third conductive layers may be attached to one another by a third adhesive layer or, preferably, by multiple (e.g. two) third adhesive layers between which a third intermediate polymer layer is disposed. The conductive layer may have a thickness of from 10 to 300 nm, preferably from 25 to 200 nm, and more preferably from 50 to 100 nm. The electronic skin may comprise electrical connection means which are suitable for electrically connecting the conductive layer, e.g. via the electrical contacts, to a signal receiver (e.g. a computer such as the control unit), the electrical connection means being preferably selected from wires, flex circuits and plug and play slots; and/or a support to which the one or more substrates are attached.

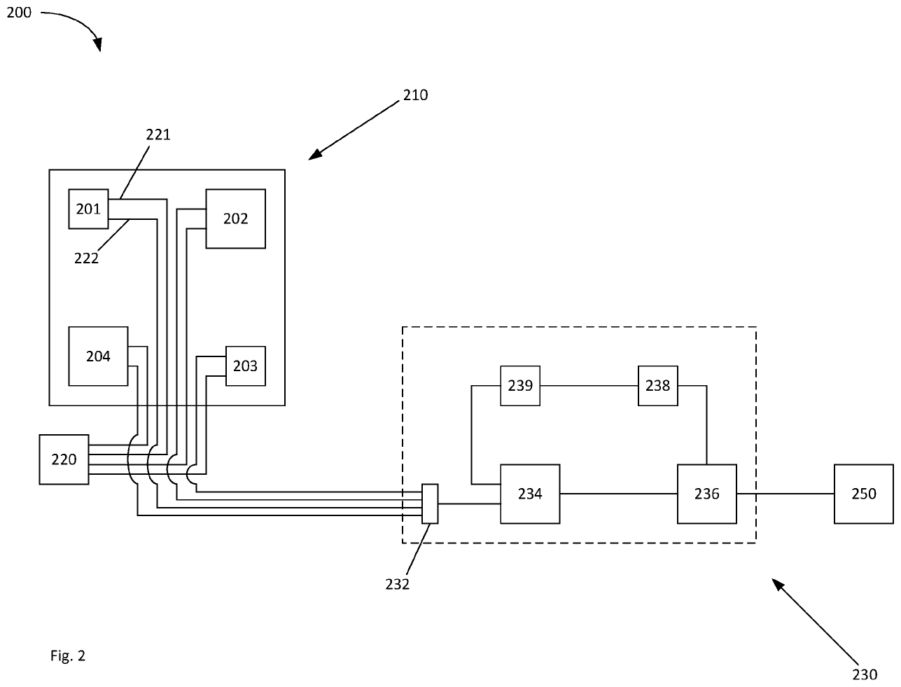

One example of a contact pressure sensing assembly and signal processing circuitry for processing signals from said contact pressure sensing assembly will now be described with reference to FIG. 2.

FIG. 2 shows a contact pressure sensing and processing system 200. The system 200 includes a contact pressure sensing assembly 210 and signal processing circuitry 230. The system 200 also includes a control unit 250.

The contact pressure sensing assembly 210 includes a plurality of contact pressure sensing regions, which, as shown in FIG. 2, includes a first contact pressure sensing region 201, a second contact pressure sensing region 202, a third contact pressure sensing region 203 and a fourth contact pressure sensing region 204. The contact pressure sensing assembly 210 also includes a voltage source 220 and a plurality of conductors (of which a first conductor 221 and a second conductor 222 are shown in FIG. 2).

The signal processing circuitry 230 includes a multiplexer 232, a differential amplifier 234, a microcontroller 236, a filtering system 238 and a calibration amplifier 239.

The voltage source 220 is connected to each of the plurality of contact pressure sensing regions. Each contact pressure sensing region is connected to the voltage source 220 via a respective conductor. The voltage source 220 provides an input voltage to each sensing region. The sensing regions are distributed about a contact surface of the sensor. Each of the sensing regions is also connected to the multiplexer 232. A respective conductor connects each sensing region to the multiplexer 232. Such conductors provide an indication of an output voltage from each contact sensing region to the multiplexer 232.

The multiplexer 232 is connected to the differential amplifier 234. The multiplexer 232 is connected to the sensor to receive, as its input, signals from each of the sensing regions. The multiplexer 232 provides, as its output, a multiplexed signal. The multiplexed signal is provided to a first input terminal of the differential amplifier 234. A second input terminal of the differential amplifier 234 is connected to an output from the calibration amplifier 239. An output terminal of the differential amplifier 234 is connected to an input of the microcontroller 236. A first output from the microcontroller 236 is connected to an input of the filtering system 238, and an output from the filtering system 238 is connected to an input for the calibration amplifier 239. A second output from the microcontroller 236 is connected to an input for the control unit 250.

Each of the contact sensing regions comprise one or more piezoresistive sensors. Each piezoresistive sensor is configured to obtain piezoresistive signals indicative of a contact pressure associated with that sensing region. Each piezoresistive sensor is connected to the voltage source 220, which applies a reference voltage to the piezoresistive sensor. The piezoresistive sensors are configured so that their resistance will vary independence on a contact pressure on that sensor. An indication of a change in voltage associated with the resistance of that sensor will thus provide an indication of the contact pressure on that sensor. The contact pressure sensing regions may be of different sizes (e.g. surface areas) and/or shapes. The sensing regions may be arranged in different locations on the electric skin to provide pressure sensing for different regions of the digits.

Each piezoresistive sensor is configured to provide, as its output, a piezoresistive signal. Each said piezoresistive signal may provide an indication of a change in voltage associated with the piezoresistive sensor, and thus an indication of contact pressure for said sensor. The system 200 is arranged to provide piezoresistive signals from each of the piezoresistive sensors to the signal processing circuitry 230. The multiplexer 232 is arranged to receive, as its input, the piezoresistive signals. The multiplexer 232 is configured to multiplex said piezoresistive signals, and to provide a multiplexed signal to the first input terminal of the differential amplifier 234. The multiplexed signal may comprise a time sequenced signal in which each piezoresistive signal received at the multiplexer 232 is sequentially applied (e.g. individually) as the input to the first terminal of the differential amplifier 234.

The differential amplifier 234 may comprise an operational amplifier. The differential amplifier 234 is configured to provide, as its output, a difference signal indicative of a difference between its two input signals. The output from the differential amplifier 234 may thus provide an indication of a difference between a signal output from the calibration amplifier 239 and a piezoresistive signal. The differential amplifier 234 may be configured to provide amplification of the difference between its two input signals (e.g. to provide gain thereto). The differential amplifier 234 may be configured to receive, at its first input terminal, a piezoresistive signal, wherein that piezoresistive signal is an analogue signal whose voltage provides an indication of the resistance of the associated sensor (e.g. an indication of the corresponding voltage drop), and thus an indication of the contact pressure for that sensor. The differential amplifier 234 may be configured to receive, at its second input terminal, a calibration signal, wherein that calibration signal is an analogue signal whose voltage is controlled by operation of the microcontroller 236, filtering system 238 and calibration amplifier 239. The differential amplifier 234 is configured to provide, as its output, the difference signal, which is an analogue signal whose voltage corresponds to a difference between the piezoresistive signal and the calibration signal. The differential amplifier 234 may be configured so that this difference signal has been amplified by the differential amplifier 234. The differential amplifier 234 may be configured to subtract the calibration signal from the piezoresistive signal, and to provide amplification thereof to provide the difference signal.

The microcontroller 236 is configured to receive the difference signal from the differential amplifier 234 as its input. The microcontroller 236 comprises an analogue to digital conversion (‘ADC’) input. The ADC input of the microcontroller 236 connects the difference signal to an ADC configured to convert the analogue difference signal into a digital signal. The microcontroller 236 may be configured to determine a voltage of the difference analogue signal (e.g. using the ADC). For example, the ADC is configured to obtain an n-bit digital signal based on the analogue difference signal provided to the ADC input of the microcontroller 236. The ADC may be configured to obtain a digital signal when the analogue difference signal is within a selected voltage range (e.g. between 0 and 5 Volts), e.g. the microcontroller 236 may measure voltage more accurately/precisely within this selected voltage range.

The ADC of the microcontroller 236 is configured to obtain an indication of a voltage for the analogue difference signal. The system 200 is configured to determine, based on this obtained indication of voltage, a voltage of the piezoresistive signal. For example, the system 200 may store an indication of a voltage for the calibration signal applied to the second input terminal of the differential amplifier 234. Using the known calibration voltage (and optionally information pertaining to the differential amplifier 234, such as any voltage increase or drop associated therewith in addition to the voltage subtraction it performs), the system 200 may be configured to determine an indication of a voltage of the piezoresistive signal. Based on the indication of this piezoresistive voltage, the system 200 is configured to determine a voltage drop associated with that pressure sensor, e.g. the system 200 is configured to determine an indication of a difference between the supply voltage and the piezoresistive voltage, and thus an indication of the resistance of the piezoresistive sensor.

The signal processing circuitry 230 is configured to control a voltage of the calibration signal provided to the second input terminal of the differential amplifier 234. The signal processing circuitry 230 is configured to control this voltage of the calibration signal based on an indication of a voltage of the difference signal (and thus the piezoresistive signal). The system 200 may be configured to control the voltage of the calibration signal to be within a selected voltage range of the voltage of the piezoresistive signal. The microcontroller 236, the filtering system 238 and the calibration amplifier 239 may form a digital to analogue converter (DAC). The DAC may be controlled so that the resulting analogue signal (the calibration signal) has a voltage which is selected based on the voltage of the difference signal (and thus based on the voltage of the piezoresistive signal).

The microcontroller 236 is configured to provide a pulse width modulated (′PWM) output signal. In other words, the microcontroller 236 is configured to sequentially provide a series of pulse width modulated pulses. The microcontroller 236 is arranged to provide such PWM output signals to the filtering system 238. The filtering system 238 may comprise one or more bandpass filters configured to provide bandpass filtering of the PWM output signal. The signal processing circuitry 230 is arranged to provide such a filtered signal to an input to the calibration amplifier 239. For example, the circuitry 230 may be arranged to provide impedance matching for this filtered signal to the input to the calibration amplifier 239. The calibration amplifier 239 may comprise an operational amplifier. The calibration amplifier 239 is configured to provide, as its output, the calibration signal, wherein that calibration signal is an analogue signal having a voltage which was controlled by the microcontroller 236 (e.g. based on the voltage of the difference signal). The calibration signal may have a voltage which is within a selected range of the voltage of the piezoresistive signal. For example, this may be within 15 V, e.g. within 10 V, e.g. within 5 V, e.g. within 3.3 V of the piezoresistive signal voltage. For example, the voltage of the calibration signal may be as close to the voltage of the piezoresistive signal as possible.

The multiplexer 232 may be configured to provide piezoresistive signals from one piezoresistive sensor for a selected time period. The system 200 may be configured to iteratively change the voltage of the calibration signal during this selected time period. For example, the system 200 may be configured to iteratively determine an indication of the voltage of the difference signal, provide a PWM output signal based on said determined voltage to provide a calibration signal to the differential amplifier 234 having a voltage selected based on the voltage of the difference signal as previously measured. The system 200 may be configured to repeat this process a plurality of times during the selected time period, e.g. to try to iteratively increment the calibration voltage towards the piezoresistive voltage. In other examples, the system 200 may be configured to perform this process once (or more) so that the difference signal voltage is within a selected voltage range, e.g. and to then monitor the voltage of that difference signal using the same calibration voltage provided to the differential amplifier 234. In the event that the voltage for the difference signal changes (e.g. so that it is no longer in the selected voltage range, and/or it is changing/has changed by more than a threshold amount), the system 200 may update the PWM output signal so that the calibration voltage is closer to that of the piezoresistive voltage.

The system 200 is configured to obtain an indication of a voltage for each of the piezoresistive signals it receives from the different piezoresistive sensors. Based on this voltage, the system 200 may be configured to determine an associated voltage drop for that sensor, and/or an indication of contact pressure associated with that sensor. In dependence on a value for these contact pressures, the system 200 is configured to control operation of the robotic arm and/or end effector/digits. For example, the system 200 is configured to control operation of the robotic arm in the manner described above depending on the value for the contact pressure associated with one or more of the piezoresistive sensors. The microcontroller 236 is also connected to the control unit 250. The microcontroller 236 is configured to provide an indication of such determined contact pressures to the control unit 250. The control unit 250 may be configured to control operation of the robotic arm/end effectors based on this received indication of contact pressure.

Such contact pressure sensing assemblies may enable an indication of the voltage drop (and thus resistance) of the piezoresistive sensors to be obtained to a high degree of precision/accuracy for a variety of different voltage values. For example, the system 200 may be configured to control the calibration voltage to be sufficiently close to the piezoresistive voltage that, irrespective of the magnitude of the piezoresistive voltage, the difference voltage may be processed by the microcontroller 236 to obtain an accurate indication for the voltage thereof.

In the above described example, the contact pressure sensing assembly 210 comprises a plurality of piezoresistive sensors. However, it is to be appreciated in the context of the present disclosure that piezoelectric sensors may be used instead of, or in addition to, piezoresistive sensors. Although not shown in the Figs., an example of a contact pressure sensing assembly will now be described in which both piezoresistive and piezoelectric sensors are used.

Such a contact pressure sensing assembly includes a plurality of piezoresistive sensors and a plurality of piezoelectric sensors. As described above, said sensors may be provided as part of an electronic skin. The electronic skin may be affixed to one or more end effectors coupled to a robotic arm. In this example, the one or more end effectors and robotic arm will be similar to those described above with reference to FIG. 1. That is, there may be a plurality of end effectors in the form of digits. The digits may be movable relative to one another to hold an item therebetween. The electronic skin is arranged to be affixed to said digits, e.g. it may be adhered (or affixed in another way) to the digits to cover a majority (if not all) of an item contacting portion of the digits. For example, the electronic skin may be configured to cover the digits so that any contact between the digits and the item will include contact between the electronic skin and the item.

The piezoresistive and piezoelectric sensors are spatially distributed about the electronic skin. The sensors may therefore be spatially distributed about the digits, so that each digit comprises one or more piezoresistive sensor, and one or more piezoelectric sensor. Typically, each digit will comprise a plurality of each type of the sensor, e.g. so that the sensors may obtain measurements for a plurality of different regions on the sensor (so that contact pressure sensing may be provided for the majority of the surface of the digits which contact items). For example, the contact pressure sensing assembly may be configured to obtain a plurality of different piezoelectric and piezoresistive sensor measurements for each digit (e.g. for different regions of each said digit).

Each of the sensors is connected to a control unit (optionally via signal processing circuitry, such as that described above) to enable an indication of a value for one or more parameters of the piezoresistive/piezoelectric signals to be obtained. The control unit is configured to control operation of the robotic arm and digits in the manner described above. That is, the control unit may obtain (e.g. determine) an indication of properties such as: a magnitude of contact pressure, a direction of contact pressure and/or whether the item is moving relative to the digits, and to control operation of the arm and digits based on such indications.

For example, the contract pressure sensing assembly may be configured to monitor parameters of a voltage of the piezoresistive signals, such as a voltage drop associated therewith, to obtain an indication of a contact pressure with the item. Using the plurality of piezoresistive sensors, the system may be configured to obtain a spatial distribution of contact pressures between the digits and the item. Monitoring the piezoresistive signals may enable real-time pressure monitoring to occur, and monitoring the piezoresistive signals may enable a spatial distribution of pressure for the item to be obtained.

The contact pressure sensing assembly may be configured to monitor parameters of a voltage of the piezoelectric signals to obtain an indication of a contact pressure with the item. The system may be configured to monitor any change in voltage for the piezoelectric signal. For example, the system may be configured to monitor any voltage extrema (e.g. maxima or minima for voltage), and/or any change in voltage (e.g. change by more than a threshold amount and/or change at more than a threshold rate). The system may be configured to determine at least one of: (i) a magnitude of any extrema, (ii) a rate of change in the voltage signal, (iii) an absolute value for change in the voltage signal, (iv) a phase associated with an extrema (e.g. peak or trough) in the voltage signal.

The system may be configured to compare different piezoelectric signals to identify any differences between such signals. For example, the system may be configured to compare a piezoelectric signal from a piezoelectric sensor on a first digit with a piezoelectric signal from a piezo electric signal on a second digit, or with a piezoelectric signal from a different piezoelectric sensor on the first digit. The system may be configured to identify one or more regions of interest in the piezoelectric signals. For example, these regions of interest will typically comprise one or more extrema (peaks or troughs), as these may provide an indication of a pressure value. The system may also be configured to monitor piezoelectric signals over time, as changes in the extrema (e.g. changes in their value, or changes in their position) may provide an indication of whether the item is correctly held. For example, the system may be configured to determine that an item is moving relative to the digits in the event that there is a change in one or more voltage extrema for the piezoelectric signals (e.g. in a given time window).

The system may be configured to monitor a position of extrema in the voltage signals from the piezoelectric sensors. The system may be configured to compare the positions for extrema in voltage signals from different sensors to determine both an indication that the item is moving, and also optionally a direction in which the item is moving. For example, the system may be configured to determine a direction of movement for the item based on a difference in phase between the different voltage signals. For example, the system may be configured to determine a direction of movement based on a difference in argument (e.g. sign—positive or negative) for the voltage extrema. For example, a negative sign may indicate movement away and positive movement towards.

The system may be configured to use such piezoelectric sensing to determine an indication of one or more properties of the contact pressure between the digits and the item, such as an indication of a magnitude and/or direction of that pressure, as well as an indication of whether the item is moving relative to the digits. Additionally, the system may be configured to utilise the one or more piezoresistive sensors in combination with said piezoelectric sensors.

It is to be appreciated in the context of the present disclosure that the piezoelectric sensors may provide complementary contact pressure data to that obtained using the piezoresistive sensors. For example, piezoelectric sensors may have a quicker response time, e.g. they may be more time-sensitive to pressure changes. As such, an indication of a change in pressure may first be observed with reference to the piezoelectric signals. It will be appreciated that piezoelectric sensors measure a charge brought about by a force applied to the piezoelectric material. This charge may leak over time (e.g. due to imperfect insulation/internal resistances of sensors and other electrical components connected thereto etc.). However, piezoresistive signals may be maintained overtime.

The system may therefore be configured to determine an ongoing indication of contact pressure for the item using piezoresistive sensors. As such, an indication of a magnitude of pressure at any given moment may be obtained using the piezoresistive sensors. The system may be configured to monitor the piezoelectric signals to identify any changes, e.g. which indicate a change in pressure/movement of the item. The system may be configured so that, in the event that a change in pressure/movement of the item is detected in one or more piezoelectric signals, the piezoresistive signals corresponding to a similar region/digit to those piezoelectric signals will then be monitored to determine a magnitude of the pressure brought about by this change/movement. The robotic arm/end effectors may therefore be controlled based on read outs from both sensors. For example, the end effectors may be initially controlled based on the piezoelectric signal (e.g. to increase/decrease the tightness of their grip—the pressure they apply). The system may then monitor the contact pressure for the relevant region of the item using the piezoresistive sensors to ensure that the contact pressure remains within a selected range. This may enable the system to be more responsive to changes in grip while still ensuring that the grip of the item is not too tight or loose.

The system may be configured to determine how to change its grip (e.g. in response to a change indicated in one or more piezoelectric signals) based on a comparison between different piezoelectric signals. For example, in the event that it is determined that the item is moving in a first direction, the system may be controlled so that one or more of the digits moves position, wherein that movement is controlled based on the determined first direction. For example, a digit may be moved into a position where it counters that movement, e.g. to ensure that the item is held in a stationary manner between the digits.

It is to be appreciated in the context of the present disclosure that the above-described examples of contact pressure sensing assemblies are not to be considered limiting. Instead, this description provides exemplary functionality of the system for controlling the operation of the end effectors/robotic arm when placing items into item containers.

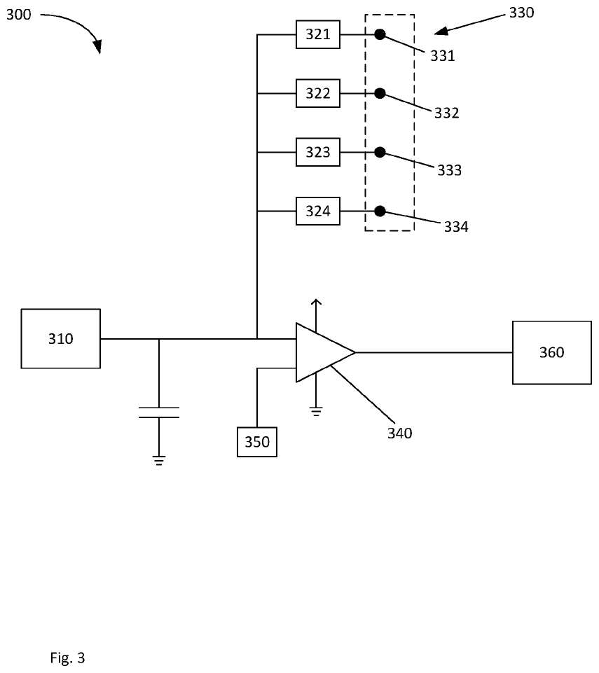

As set out above, the relative resistances of the piezoelectric sensors may vary depending on contact pressure. Additionally, the resistance of such piezoelectric sensors may vary depending on e.g. properties of their manufacture, their size and shape etc. To improve sensor precision/accuracy for any given contact pressure sensing assembly, it may be preferable to obtain an indication of a baseline resistance for said piezoresistive sensors, e.g. to obtain an initial value for expected resistances brought about by that piezoresistive sensor. An exemplary ohmmeter designed to enable such resistances to accurately be measured (even if the resistance to be measured could be in a plurality of different resistance ranges) will now be described with reference to FIG. 3.

FIG. 3 shows an ohmmeter 300 which is configured to measure a voltage drop across a piezoresistive sensor to determine a resistance of the piezoresistive sensor in each of a plurality of different, separate, resistance ranges.

The ohmmeter 300 includes a piezoresistive sensor coupling port 310, as well as a plurality of resistors (FIG. 3 shows a first resistor 321, a second resistor 322, a third resistor 323, and a fourth resistor 324). The ohmmeter 300 also includes a microcontroller 330 which includes a plurality of connecting pins (FIG. 3 shows a first pin 331, a second pin 332, a third pin 333, and a fourth pin 334). The ohmmeter 300 also includes a differential amplifier 340, a reference signal provider 350 and a control unit 360.

The coupling port 310 is connected to each of the resistors. Each of the resistors is connected to a respective corresponding pin of the microcontroller (e.g. the first resistor is connected to the first pin, etc.). The coupling port 310 may also be connected to the first plate of a capacitor (as shown in FIG. 3), e.g. wherein the second plate of said capacitor is coupled to a reference signal provider 350, which may comprise a reference voltage, such as ground. The connection between the coupling port 310 and the first plate of the capacitor may be between the connection between the coupling port 310 and the resistors. The connection between the coupling port 310 and the resistors is connected to a first input terminal of the differential amplifier 340. The reference signal provider 350 is connected to a second input terminal of the differential amplifier 340. An output terminal of the differential amplifier 340 is connected to the control unit 360.

The coupling port 310 is configured to be coupled to an output from one or more piezoresistive sensors. For example, the coupling port 310 may be configured to couple to the output conductors shown in FIG. 2 to receive piezoresistive signals from the one or more piezoresistive sensors. The capacitor may be arranged to provide filtering, e.g. to reduce noise from AC lines of the system. The system is arranged to provide a conductive path between the coupling port 310 and each of the plurality of resistors.

The microcontroller is configured to control a pin status of each of the pins. The microcontroller is operable to provide the pin status in either an input mode, or an output mode. For the output mode, the microcontroller is configured to simulate that the resistor connected to the pin is connected to a reference voltage (e.g. 5 V or 3.3 V) by outputting a logical 1 value on said pin, or to simulate that said resistor is connected to ground by outputting a logical 0 value on said pin. The microcontroller may be configured to simulate that a resistor is disconnected from the circuit by selecting the pin state for the pin corresponding to that resistor to be in an input mode. For example, each of the resistors may be virtually added or removed by controlling operation of the microcontroller (with reference to the first input terminal of the differential amplifier 340).

The differential amplifier 340 may comprise an operational amplifier. For example, the first terminal (to which the connection between the coupling port 310 and the resistors is connected) may be the non-inverting terminal. For example, the second terminal (to which the reference voltage is applied) may be the inverting terminal. The differential amplifier 340 is configured to provide, as its output, a difference signal indicative of a difference between its two input signals. The output from the differential amplifier 340 may thus provide an indication of a difference between a signal received from: (i) the connection between the coupling port 310 and the resistors, and (ii) the reference signal provider 350. The differential amplifier 340 may be configured to provide amplification of the difference between its two input signals (e.g. to provide gain thereto). The differential amplifier 340 may be configured to receive, at its first input terminal, a signal based on a piezoresistive signal obtained from a piezoresistive sensor. For example, such a piezoresistive signal may comprise an analogue signal whose voltage provides an indication of the resistance of the associated sensor (e.g. an indication of the corresponding voltage drop across that sensor).

The differential amplifier 340 may be configured to receive, at its second input terminal, a reference signal, wherein that reference signal is an analogue signal whose voltage is provided by the reference signal provider 350. The differential amplifier 340 is configured to provide, as its output, a difference signal, which is an analogue signal whose voltage corresponds to a difference between the two input signals to the differential amplifier 340.

The differential amplifier 340 may be configured so that this difference signal has been amplified by the differential amplifier 340. The differential amplifier 340 may be configured to subtract the reference signal from the signal from the connection between the coupling port 310 and the resistors, and to provide amplification thereof to provide the difference signal. The control unit 360 is configured to process signals output from the differential amplifier 340, e.g. to determine a voltage associated therewith. The control unit 360 is also configured to control operation of the microcontroller (and its pin status). For example, the control unit 360 and the microcontroller may be provided by the same component, i.e. the same microcontroller. For example, the output from the differential amplifier 340 may be provided to the ADC input of the microcontroller.

The ohmmeter 300 is arranged to enable one or more of the resistors to form a potential divider with the first input terminal of the differential amplifier 340. The ohmmeter 300 is configured so that the plurality of resistors are selectively operable to vary the voltage provided to the first input terminal of the differential amplifier 340, e.g. the ohmmeter 300 is arranged so that a voltage of the piezoresistive signal received at the coupling port 310 will be divided between the input terminal of the differential amplifier 340 and one or more of the resistors. By controlling operation of the microcontroller to activate more, or larger resistance, resistors, the voltage input to the first terminal of the differential amplifier 340 will be reduce. The system is configured to control the effective resistance of the potential divider (e.g. to control which and how many of the resistors are activated to control the total resistance of the potential divider), thereby to control a voltage provided to the first input terminal of the differential amplifier 340.

The ohmmeter 300 is configured so that the microcontroller may selectively activate resistors by controlling the pin status of the pin to which each resistor is connected. Therefore, the ohmmeter 300 may be configured to increase the effective resistance by increasing the number of resistors which are activated. Additionally, the resistors may each have different resistance values. The different resistance values may be in different selected ranges. For example, the system may comprise resistors which respectively have a resistance in ohms, kilohms, megaohms, and/or giga-ohms. In other examples, the differences in resistances may less coarsely separated, and/or one or more of the resistors may have the same (or similar) resistance value. For example, where the resistors are separated by a large amount of resistance, only one resistor may be activated at a time (e.g. because the incremental resistance provided by combining two resistances may effectively be negligible as compared to one of the total resistance).

The Ohmmeter 300 is configured to control which, and how many, of the resistors are activated by controlling the pin status of the microcontroller. It will be appreciated in the context of the present disclosure that a plurality of resistors may be provided, and that the ohmmeter 300 may selectively activate resistors until the output from the differential amplifier 340 is within a selected voltage range. In other words, the ohmmeter 300 may be controlled so that the voltage provided to the first terminal of the differential amplifier 340 may be within a threshold voltage range of that provided by the reference signal provider 350. The ohmmeter 300 may be configured to iteratively change the state of the microcontroller pins until the output from the differential amplifier 340 is within the selected range. For example, the ohmmeter 300 may be configured to try to determine a voltage of the difference signal output from the differential amplifier 340 (e.g. using the ADC input port of the microcontroller), and to either output that voltage (in the event that the voltage is determinable) or to change the effective resistance by changing the pin state of one or more pins (in the event that the voltage is not determinable, or is outside a desired range).

The control unit 360 is configured to monitor the difference signal from the differential amplifier 340 and to control the state of each microcontroller pin based on said difference signal until the voltage provided to the first input terminal of the differential amplifier 340 is within the selected range from the reference voltage. This may comprise iteratively decreasing the effective resistance applied to a piezoresistive signal received at the coupling port 310 until the voltage provided to the first input terminal of the differential amplifier 340 is within the selected range from the reference voltage.

For this, the ohmmeter 300 may be configured to start measuring in an initial measurement state. In the initial measurement state, the microcontroller pin statuses are controlled to provide a high effective resistance. This may comprise activating the highest resistance resistor, and/or activating more than one of the resistors. The ohmmeter 300 is configured to then try to measure a resulting difference signal from the differential amplifier 340. In the event that the effective resistance in the potential divider (as provided by the one or more activated resistors) is in a suitable range, such that this difference signal may be measured (e.g. a voltage of the difference signal is within the operational range of the ADC of the microcontroller), this measurement of the voltage may be provided in an output signal from the microcontroller, e.g. to a display, or another control system. In the event that the effective resistance in the potential divider is too high, such that a voltage of the difference signal may not be meaningfully measured, the ohmmeter 300 may control the pin status of one or more of the pins of the microcontroller to de-activate one or more of the resistors. For example, the highest value resistor may be de-activated and/or fewer resistors may be activated, or any other combination of activated resistors may be provided so that the total resistance in the potential divider is decreased. The ohmmeter 300 may then try to measure the resulting difference signal from the differential amplifier 340. This process will be repeated until a voltage of the difference signal may be determined, e.g. the effective resistance of the potential divider will be iteratively decreased until a voltage measurement may be obtained. This may inhibit voltages which are too high being provided to the microcontroller.

In examples described herein, circuitry is provided to measure a parameter (e.g. voltage) of one or more piezoresistive and/or piezoelectric signals. In some examples, these signals may be used to determine an indication of a contact pressure for the associated sensor. Apparatuses of the present disclosure may comprise a display configured to display an indication of a measurement value. For example, apparatuses of the present disclosure may comprise one or more lights configured to indicate a value of the measured signal. The lights may indicate a magnitude of the sensed value, e.g. by changing colour, and/or intensity of the magnitude of the sensed value. For example, in systems described herein, one or more end effector may comprise one or more lights which are configured to indicate a magnitude of a contact pressure between said end effectors and the item held by that end effector. Signal processing circuitry for such sensors may comprise one or more splitters configured to direction a portion of the piezoresistive signal to the display (e.g. to the one or more lights). The signal processing circuitry may comprise one or more diodes configured to power the display based on the piezoresistive signal. For example, the circuitry may be configured to control the colour and/or intensity of the lights using the power generated by the diode.

It is to be appreciated in the context of the present disclosure that, while there has been description of the first end effector 120 with three digits, this is not to be considered limiting. There may be two digits, or there may be more than three. The first end effector 120 may comprise an digit which does not move, so that movement of the digits comprises movement of only one (or more than one) digit towards/away from the non-moving digit. For example, the first end effector 120 may comprise a non-moving wall portion in combination with an digit to enable grasping of the item therebetween. It will be appreciated in the context of the present disclosure that, while reference has been made to robotic arms having one or more end effectors, and such end effectors comprising one or more digits, other types of end effector may be provided. For example, one or more end effectors may comprise suction cups or other vacuum-based end effector.

Exemplary robotic arms (e.g. for the first or second robotic arm) may comprise a robotic arm sold under the trade name Elfin 5 produced by Hans Robot, such as the Elfin5.19 or Elfin5.21. Embodiments of the present disclosure may utilise one or more 3-dimensional cameras, such as those sold under the trade name of MV-CA050-10GC produced by HIKrobotics.

It will be appreciated from the discussion above that the examples shown in the figures are merely exemplary, and include features which may be generalised, removed or replaced as described herein and as set out in the claims. With reference to the drawings in general, it will be appreciated that schematic functional block diagrams are used to indicate functionality of systems and apparatus described herein. In addition, the processing functionality may also be provided by devices which are supported by an electronic device. It will be appreciated however that the functionality need not be divided in this way, and should not be taken to imply any particular structure of hardware other than that described and claimed below. The function of one or more of the elements shown in the drawings may be further subdivided, and/or distributed throughout apparatus of the disclosure. In some examples the function of one or more elements shown in the drawings may be integrated into a single functional unit.

As will be appreciated by the skilled reader in the context of the present disclosure, each of the examples described herein may be implemented in a variety of different ways. Any feature of any aspects of the disclosure may be combined with any of the other aspects of the disclosure. For example method aspects may be combined with apparatus aspects, and features described with reference to the operation of particular elements of apparatus may be provided in methods which do not use those particular types of apparatus. In addition, each of the features of each of the examples is intended to be separable from the features which it is described in combination with, unless it is expressly stated that some other feature is essential to its operation. Each of these separable features may of course be combined with any of the other features of the examples in which it is described, or with any of the other features or combination of features of any of the other examples described herein. Furthermore, equivalents and modifications not described above may also be employed without departing from the invention.

Certain features of the methods described herein may be implemented in hardware, and one or more functions of the apparatus may be implemented in method steps. It will also be appreciated in the context of the present disclosure that the methods described herein need not be performed in the order in which they are described, nor necessarily in the order in which they are depicted in the drawings. Accordingly, aspects of the disclosure which are described with reference to products or apparatus are also intended to be implemented as methods and vice versa. The methods described herein may be implemented in computer programs, or in hardware or in any combination thereof. Computer programs include software, middleware, firmware, and any combination thereof. Such programs may be provided as signals or network messages and may be recorded on computer readable media such as tangible computer readable media which may store the computer programs in non-transitory form. Hardware includes computers, handheld devices, programmable processors, general purpose processors, application specific integrated circuits (ASICs), field programmable gate arrays (FPGAs), and arrays of logic gates. Control units described herein may be provided by any control apparatus such as a general-purpose processor configured with a computer program product configured to program the processor to operate according to any one of the methods described herein.

Other examples and variations of the disclosure will be apparent to the skilled addressee in the context of the present disclosure.

1. An item picking system configured to pick items from a collection region for placing said items into an item container, the system comprising:
a robotic arm;
one or more end effectors coupled to the robotic arm for holding and manipulating an item, wherein at least one of the end effectors comprises a contact pressure sensing assembly including a piezoresistive sensor configured to obtain piezoresistive signals indicative of contact pressure between said sensor and an item held by said end effector;
signal processing circuitry configured to process the piezoresistive signals, the signal processing circuitry comprising a differential amplifier having:
(i) a first input terminal coupled to the sensor to receive the piezoresistive signals therefrom;
(ii) a second input terminal arranged to receive a calibration signal; and
(iii) an output terminal for providing a difference signal based on the two input signals,
wherein, for each piezoresistive signal provided to the differential amplifier, the system is configured to control the calibration signal provided to the second input terminal of the differential amplifier to be within a selected range from said piezoresistive signal; and
a control unit coupled to the output terminal of the differential amplifier, wherein the control unit is configured to control operation of the robotic arm based on the difference signals from the differential amplifier;

2. The item picking system of claim 1, wherein the control unit is configured to control at least one of the end effectors to change its grip on the item in the event that the difference signal indicates at least one of: (i) the contact pressure between the sensor and the item held by said end effector is outside a selected pressure range, (ii) the contact pressure between the sensor and the item held by said end effector has changed by more than a threshold amount while the item has been grasped by said end effector, (iii) the contact pressure between the sensor and the item held by said end effector is changing at above a threshold rate of pressure change.

3. The item picking system of claim 2, wherein the control unit is configured to control at least one of the end effectors to change its grip on the item to increase the contact pressure in the event that the contact pressure: is below a threshold value, has decreased by more than the threshold amount, and/or is decreasing above the threshold rate.

4. The item picking system of claim 1, wherein the pressure sensing assembly of the end effector comprises a plurality of piezoresistive sensors configured to obtain piezoresistive signals indicative of contact pressure between each said sensor and the item held by the one or more end effectors.

5. The item picking system of claim 1, wherein the control unit is configured to: (i) obtain an indication of a value for the piezoresistive signal, and (ii) generate a calibration signal to be provided to the second input terminal based on the indication of the value for the piezoresistive signal.

6. The item picking system of claim 5, wherein the control unit is configured to generate the calibration signal to be within a selected voltage range of a voltage of the piezoresistive signal, for example wherein the selected voltage is within 15 volts of the voltage of the piezoresistive signal.

7. The item picking system of claim 1, wherein the end effector comprises one or more lights configured to indicate a value for a contact pressure between the one or more end effectors and the item held by the end effectors.

8. The item picking system of claim 7, wherein the signal processing circuitry comprises a splitter configured to direction a portion of the piezoresistive signal to the one or more lights, for example wherein the signal processing circuitry comprises a diode configured to power the display based on the piezoresistive signal.

9. The item picking system of claim 1, wherein the pressure sensing assembly further comprises a piezoelectric sensor configured to obtain piezoelectric signals indicative of contact pressure between said piezoelectric sensor and an item held by the digits, and wherein the control unit is configured to control operation of the robotic arm based on a comparison between the piezoelectric signals and the piezoresistive signals.

10. A contact pressure sensing assembly comprising:
an electronic skin for digits of an end effector of a robotic arm, wherein the electronic skin comprises:
a plurality of piezoresistive sensors each configured to obtain piezoresistive signals;
a plurality of piezoelectric sensors each configured to obtain piezoelectric signals;
a control unit coupled to the electronic skin to receive the piezoresistive and piezoelectric signals therefrom;
wherein the control unit is configured to process the piezoresistive signals to identify one or more piezoresistive parameters associated therewith, and to process the piezoelectric signals to identify one or more piezoelectric parameters associated therewith;
wherein the control unit is operable to identify that an item held by the digits of the end effector is moving relative to the electronic skin based on a difference in magnitude and/or phase between: (i) one or more of the piezoelectric parameters in piezoelectric signals from one piezoelectric sensor, and (ii) one or more of the piezoelectric parameters in piezoelectric signals from another piezoelectric sensor; and
wherein the control unit is configured to determine a contact pressure between the item and a first digit associated with said one piezoelectric sensor based on one or more of the piezoresistive parameters from piezoresistive signals associated with the first digit.

11. The pressure sensing assembly of claim 10, wherein in response to identifying that an item held by the digits of the end effector is moving relative to the electronic skin for the first digit based on the piezoelectric signals, the control unit is configured to monitor piezoresistive signals associated with the first digit to confirm that the item is moving relative to the electronic skin for the first digit.

12. The pressure sensing assembly of claim 10, wherein the control unit is configured to determine a direction of movement of the item based on a phase difference between different piezoelectric signals.

13. The pressure sensing assembly of claim 12, wherein for at least one of the digits of the end effector, the electronic skin comprises a first piezoelectric sensor and a second piezoelectric sensor located away from the first piezoelectric sensor; and
wherein the control unit is configured to determine whether the item is moving in the direction of the first piezoelectric sensor or the second piezoelectric sensor based on piezoelectric signals from the first and second piezoelectric sensors.

14. The pressure sensing assembly of claim 10, wherein the one or more piezoresistive parameters comprise a change in voltage associated with the sensor, and/or wherein the one or more piezoelectric parameters comprise any of: a maximum voltage, a minimum voltage, a change in voltage and/or a rate of change of voltage.

15. An item picking system configured to pick items from a collection region for placing said items into an item container, the system comprising:
a robotic arm; and
an end effector coupled to the robotic arm comprising at least two digits for holding and manipulating an item therebetween, wherein the end effector comprises a contact pressure sensing assembly;
wherein the contact pressure sensing assembly comprises an electronic skin arranged to at least partially cover the digits of the end effector, the electronic skin comprising: (i) a plurality of piezoresistive sensors each configured to obtain piezoresistive signals; and (ii) a plurality of piezoelectric sensors each configured to obtain piezoelectric signals;
wherein the system comprises a control unit configured to control operation of the digits based on piezoelectric signals and piezoresistive signals received from the electronic skin.

16. The item picking system of claim 15, wherein the control unit is operable to identify that an item held by the digits of the end effector is moving relative to the electronic skin based on a difference in magnitude and/or phase between: (i) one or more voltage parameters for piezoelectric signals from one piezoelectric sensor, and (ii) one or more voltage parameters for piezoelectric signals from another piezoelectric sensor.

17. The item picking system of claim 16, wherein the control unit is configured to control at least one of the digits to move in the event that it is determined that an item held by the digits of the end effector is moving relative to the electronic skin.

18. The item picking system of claim 15, wherein the control unit is configured to determine a direction of movement of the item based on a phase difference between different piezoelectric signals.

19. The item picking system of claim 18, wherein the control unit is configured to control at least one of the digits to move relative to the item, wherein the control unit is configured to determine a direction in which the digit is to move based on the determined direction of movement of the item.

20. The item picking system of claim 15, wherein in the event that the control unit determines that the item is moving relative to a first digit the control unit is configured to determine a contact pressure between the item and the first digit based a change in voltage from piezoresistive signals on the first digit.

21-25. (canceled)
